(19) United States
(12) Patent Application Publication
(10) Pub. No.: US 2014/0032606 A1
(43) Pub. Date: Jan. 30, 2014

(54) COLLAPSIBLE GROUPS IN GRAPHICAL WORKFLOW MODELS

(71) Applicants: Elham Chandler, Los Altos, CA (US); Jingqi Xian, San Jose, CA (US)

(72) Inventors: Elham Chandler, Los Altos, CA (US); Jingqi Xian, San Jose, CA (US)

(73) Assignee: Adobe Systems Incorporated, San Jose, CA (US)

(21) Appl. No.: 12/544,686

(22) Filed: Aug. 20, 2009

(51) Int. Cl. G06F 3/048; G06F 17/30

(52) U.S. Cl. 707/798; 715/771; 707/E17.005

(57) ABSTRACT

Various embodiments include at least one of systems, methods, software, and data structures for creating, modifying, and presenting collapsible groups in graphical workflow models in workflow process applications. Some embodiments include providing a presentable workflow modeling user interface including a graphical model of a modeled workflow process including multiple elements and receiving data indicative of first input selecting at least two elements to be grouped. Such an embodiment may further include building a data structure representative of the at least two elements to be grouped, storing the data structure, and modifying the graphical model by replacing the at least two elements to be grouped with a single element representative of the grouping.

### BACKGROUND INFORMATION

Many computer applications include workflow processes having multiple activities to be performed and links or routing between the activities. To define and configure such workflows, these computer applications often include workflow authoring interfaces that provide a graphical view of a workflow model including nodes representing activities and lines that represent the links or routing. These graphical views often are displayed as flow charts.

When authoring, or simply viewing, a modeled workflow process including several nodes, the display area of the application is often too small and must be scrolled or zoomed-out to view an entire process. As a result, viewing modeled workflow processes can become cumbersome as a workflow process grows in size or complexity.

### BRIEF DESCRIPTION OF THE DRAWINGS

FIG. 1 is a block diagram of a system according to an example embodiment.

FIG. 2 is a block diagram of a computing device according to an example embodiment.

FIG. 3 is a user interface diagram, illustrating a user interface, according to an example embodiment.

FIG. 4 is a user interface diagram, illustrating a user interface, according to an example embodiment.

FIG. 5 is a user interface diagram, illustrating a user interface, according to an example embodiment.

FIG. 6 is a user interface diagram, illustrating a user interface, according to an example embodiment.

FIG. 7 is a user interface diagram, illustrating a user interface, according to an example embodiment.

FIG. 8 is a block flow diagram of a method according to an example embodiment.

### DETAILED DESCRIPTION

When designing processes in workflow process applications, processes can quickly become cluttered and unreadable within a workflow process authoring canvas as workflow elements are added to the canvas. For example, the number of elements graphically represented on a canvas may grow to a size where not all of the elements can be viewed in a single view of the workflow process modeled on the canvas, or at least cannot be viewed in a manner whereby details of the modeled workflow may be easily read. As a result, views of the canvas are displayed in a zoomed state allowing either viewing of a large portion of the workflow process or of a small portion of the workflow process displayed large enough to be readable. However, zoomed solutions create further issues, such as an inability for simultaneous viewing of a link or route source and destination in a single, readable view. To address these and other issues, various embodiments herein include at least one of visualization and data storage mechanisms to provide greater flexibility in designing and viewing workflow processes.

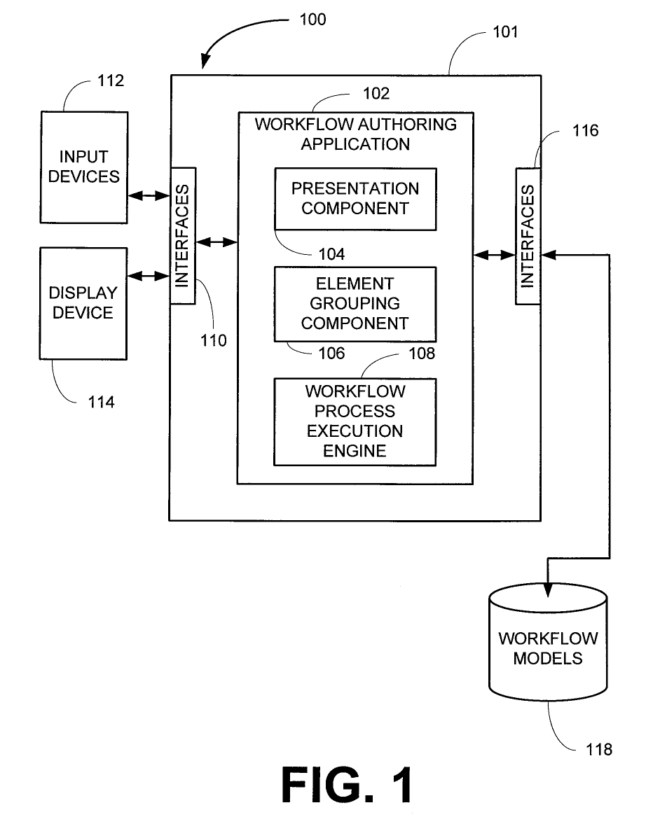

FIG. 1 is a block diagram of a system 100 according to an example embodiment. The system 100 is an example of a system including a computer 101 having a workflow authoring application 102 installed and operable thereon. The system 100 includes the computer 101 having at least one processor, at least one memory device, and at least one storage device. The at least one storage device stores instructions that may be loaded into the at least one memory device and executed by the at least one processor. The instructions of the system 100 include instructions defining the workflow authoring application 102.

In some embodiments, the workflow authoring application 102 includes a presentation component 104 and an element grouping component 106. In some embodiments, the workflow authoring application may also include a workflow process execution engine 108 that provides an execution environment for execution of workflows models authored within the workflow authoring application 102. However, execution of the workflow models, in other embodiments, may occur in other applications on the computer 101 or on another computer.

The presentation component 104 is executable by the at least one processor to present a view of a canvas on a display device 114 of the computer 101. The display device 114 may be connected to the computer 101 via an interface of a set of multiple input/output interfaces 110 of the computer. The display device 114 is typically connected to an output interface of a graphics circuit, often referred to as a graphics card. Also connected to the multiple interfaces 110 are one or more input devices 112, such as a keyboard and a pointing device. The pointing device typically includes a mouse, touch pad, a stylus that may be utilized to provide input in embodiments when the display device 114 is a touch screen, and other similar input devices.

The presentation component 104 as it is executed provides a canvas upon which workflows may be modeled. As a workflow is modeled, the model may be stored on the one or more data storage devices of the computer 101 or in a remote data storage location 118. The remote data storage location 118 may be a networked storage location that may be accessed via one of multiple possible interfaces 116. These multiple interfaces 116 may include a network interface device, such as a wired or wireless network card, that provides data communications services over one or more networks to the computer 101 and applications executing thereon, such as the workflow authoring application 102. The multiple interfaces 116 may also, or alternatively, include a bus interface, such as a Universal Serial Bus (USB) interface that may be connected to data storage devices or other USB peripheral devices.

Workflows may be modeled within the canvas presented by the presentation component on the display device 114. A workflow model includes workflow elements including routes from workflow elements to other workflow elements. The workflow elements, in some embodiments, are each representative of one of an activity, event, sub-process, branch, or other workflow item that a workflow author may choose to include in a workflow model. Elements may also be referred to as nodes.

An activity is typically a task that is performed by a human or a data processing resource, such as a computer or hardware or software component thereof. An event is an occurrence of an activity, such as receipt of a message, modification or creation of a stored data value, or other occurrence that is either detected in or input into a workflow process. A sub-process is typically a process that executes outside of a workflow process application, such as a stored procedure that executes within a database management system, a web service called or data received by a workflow process application, a manual process performed by an external entity or other department of an organization, and the like.

A branch is an entry point or exit point to or from parallel or conditional portions of a workflow process. In some embodiments, a branch includes a branch open point and a branch close point. A branch open element may include underlying conditional logic that evaluates data to determine which branch of multiple workflow branches to follow in a workflow process. Alternatively, a branch open element may provide a route into each of multiple workflow branches that are performed in parallel. A branch close element closes processing of the branching, such as by waiting for all branches that are executed or performed in parallel to complete before continuing to a route out of the branch element. When the branching is conditional, the branch close, when reached, may simply continue to a route out of the branch element. In further embodiments, a branch open element may include conditional logic that evaluates data to identify two or more of multiple possible branches that will be executed or performed in parallel. In such embodiments, the branch close element waits for each of the two or more identified branches to complete before continuing in the workflow process.

As a workflow is modeled within the canvas provided by the presentation component 104, the area of the canvas often becomes cluttered. In some embodiments, rather than having a fixed size, the canvas may be scaled to provide enough room for all needed workflow elements. However, as the canvas is scaled, it may become difficult to view an entirety of a workflow model in a single view. In such instances, the canvas may be scrolled. In other embodiments, where the canvas is of a fixed size, the number of elements may become too great for the presentation component 104 to provide a view with sufficient detail for the modeled workflow to be visually presented in a useful manner. Thus, in some embodiments, the element grouping component 106 is operable to group workflow elements into a single graphical element that may be presented by the presentation component 104. For example, a user may select multiple workflow elements provided in a canvas view by the presentation component 104 and provide input to group the selected elements. The presentation component 104 may then pass data identifying the selected elements to the element grouping component 106. The element grouping component may then modify a data structure underlying the workflow model to place the selected elements in a group. Data is then returned to the presentation component 104, such as a message indicating the grouping is complete, and the presentation component 104 may cause the workflow model to be redrawn on the canvas and presented via the display device 114. The redrawn workflow model will include the grouping of the selected elements.

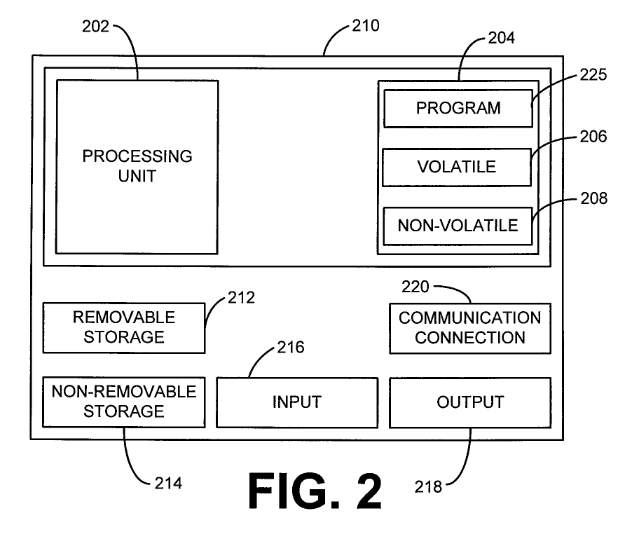

FIG. 2 is a block diagram of a computing device according to an example embodiment. The computing device of FIG. 2 is an example of a computing device that may be implemented as the computer 101 of FIG. 1. The techniques describe herein may be implemented in such a computing device, such as the methods of the various described embodiments. In one embodiment, multiple such computer systems are utilized in a distributed network to implement multiple components in a transaction-based environment. An object-oriented architecture may be used to implement such functions and communicate between the multiple systems and components. One example computing device in the form of a computer 210, may include at least one processing unit 202, memory 204, removable storage 212, and non-removable storage 214. Memory 204 may include volatile memory 206 and non-volatile memory 208. Computer 210 may include—or have access to a computing environment that includes—a variety of computer-readable storage mediums, such as volatile memory 206 and non-volatile memory 208, removable storage 212 and non-removable storage 214. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 210 may include or have access to a computing environment that includes input 216, output 218, and a communication connection 220. The computer may operate in a networked environment using a communication connection to connect to one or more remote computers, such as database servers and application servers. The remote computer may include a personal computer (PC), a desktop computer, a laptop computer, a notebook computer, netbook computer, workstation, mainframe computer system, handheld computer, application server or other server type, router, network PC, a peer device or other common network node, or the like. The computer may also include a consumer electronics device such as a camera, camcorder, set top box, mobile device, video game console, handheld video game device, an electronic book reading device, or in general any type of computing or electronic device. The communication connection may include a connection via a network interface device to one or more of a Local Area Network (LAN), a Wide Area Network (WAN), the Internet, and other networks.

Computer-readable instructions stored on a computer-readable storage medium are executable by the at least one processing unit 202 of the computer 210. A hard drive, CD-ROM, and RAM are some examples of articles including a computer-readable storage medium. For example, a computer program 225 may be stored on one or more computer-readable storage mediums. The computer program 225 may include instructions executable by the at least one processing unit 202 to perform one or more of the methods and provide the user interfaces and functionality as described herein. In some embodiments, the computer program 225 is the workflow authoring application 102 of FIG. 1 that includes at least the presentation component 104 and the element grouping component 106.

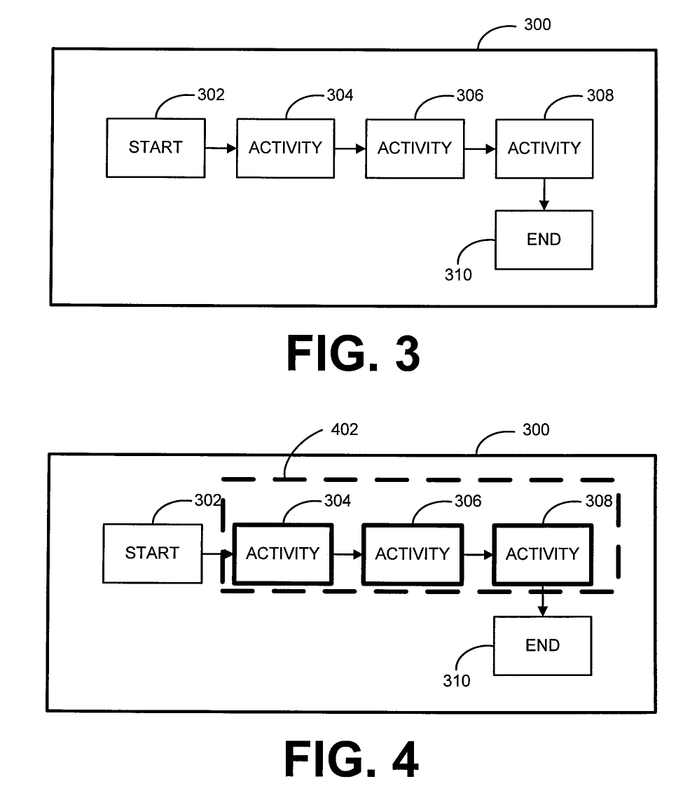

FIG. 3 is a user interface diagram, illustrating a user interface, according to an example embodiment. The user interface includes a workflow process authoring and viewing canvas 300, also simply referred to as a canvas. The canvas 300 includes elements 302, 304, 306, 308, and 310. The elements are each representative of one of an activity, event, sub-process or other workflow item that a workflow author may choose to include in a workflow model. Elements may also be referred to as nodes.

An activity is typically a task that is performed by a human or a data processing resource, such as a computer. An event is an occurrence of an event, such as receipt of a message, modification or creation of a stored data value, or other occurrence that is either detected in or input into a workflow process. A sub-process is typically a process that executes outside of a workflow process application, such as a stored procedure that executes within a database management system, a web service called or data received by a workflow process application, a manual process performed by an external entity or other department of an organization, and the like.

The elements 302, 304, 306, 308, and 310 of the modeled workflow process presented on the canvas 300 includes start element 302 which denotes the starting point of the modeled workflow process and an end element 310 which denotes the ending pint of the modeled workflow process. The remaining elements 304, 306, and 308 denote activities as defined above. The elements 302, 304, 306, 308, and 310 are linked together by lines with arrowheads that identify the direction of flow in the modeled workflow. These lines are often referred to as routes. An element may include more than one inbound route, except the start element, which typically does not include an inbound route. In some workflow process applications, elements may include only a single outbound route, although that outbound route may flow into a branching element. For example, in some workflow process applications, an additional element is available that is referred to as a branching element. A branching element is an element that represents conditional routing from one or more inbound routes to one or more outbound routes. A branching element may apply “IF . . . THEN . . . ” testing, “CHOOSE . . . CASE . . . ” testing, and other forms of logical testing to identify an outbound route to a next element in a workflow process.

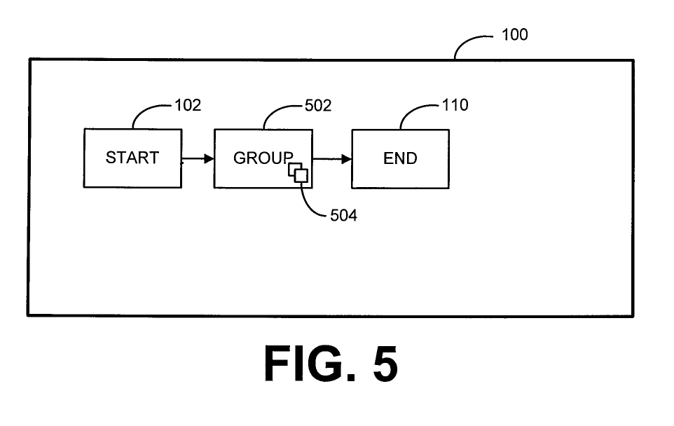

An author of the modeled workflow process on the canvas 300 may desire to consolidate portions of the modeled workflow process to reduce the amount of visual space on the canvas 300 consumed by the graphical elements 302, 304, 306, 308, and 310. The author may desire to reduce the space for any number of reasons, such as conserving space to increase the amount of a modeled workflow process presented in a viewable area of the canvas 300, removing or reducing a need to scroll the viewable area of the canvas. Consolidating elements may also be used to simplify a view of the modeled workflow process. An example of consolidating elements of the modeled workflow process is illustrated and described with regard to FIG.4 and FIG. 5.

FIG. 4 is a user interface diagram, illustrating a user interface, according to an example embodiment. The user interface of FIG. 4 includes the canvas 300 and the elements 302, 304, 306, 308, and 310 as illustrated in FIG. 3. In this instance though, a user has selected elements 304, 306, and 308. The selection of the elements 304, 306, and 308, in some embodiments is made using one or more input devices, such as a pointing device (e.g., a mouse or touch pad) and a keyboard. For example, the user may left click a pointing device on the canvas 300 and drag a box 402 around the elements 304, 306, and 308 to select these elements for consolidation into a single element. The act of consolidating the selected elements 304, 306, and 308 into a single element is referred to as collapsing the elements. Thus, following selection of the elements 304, 306, and 308, the user provides additional input and the elements 304, 306, 308 are collapsed into a single graphical element that represents a group. The additional input may be provided through selection of a menu item that may popup automatically upon selection of the elements 304, 306, 308 or upon a right click of a pointer device. An example of the elements 304, 306, and 308 collapsed into a single element is illustrated in FIG. 5.

FIG. 5 is a user interface diagram, illustrating a user interface, according to an example embodiment. The user interface of FIG. 5 includes the canvas 300 and the start and end elements 302 and 310. The collapsed elements 304, 306, and 308 have been replaced by group 502 element which reduces the amount of space consumed by the collapsed elements considerably. However, although collapsed, the elements 304, 306, and 308 may be redisplayed by expanding the group 502, such as by a double left click of the group by a pointing device. The group 502, when expanded, replaces the group 502 with the elements 304, 306, and 308 with an indication that the elements are grouped, such as by box 402 of FIG. 4. The elements may be re-collapsed into the form illustrated in FIG. 5. To visually indicate that the group 502 does represent a group, the element may include a visual indicator, such as visual indicator 504.

When elements are placed into a group, such as the elements 304, 306, and 308 in group 502, the group may be copied and pasted to replicate the entire group in another location of the canvas 300. Thus, not only does grouping provide abilities to modify how the elements on a canvas are presented, grouping also provides an ability to rapidly replicate portions of a modeled workflow process including routes into and out of a grouping. When pasted, the inputs and outputs of the copied and pasted group may include unconnected inbound and outbound routes. Those routes may then be connected to other elements of the workflow within which the group is pasted. When a group is pasted in a workflow model, the underlying data of the group is also pasted into the underlying data structure of the workflow model. The copying and pasting of a group may be performed through selection of copy and paste menu items, keyboard key combinations, and the like.

A workflow model displayed on the canvas 300 includes an underlying data structure that holds the data visually represented on the canvas 300. The data may be stored in memory, on a data storage device such as a hard drive, in a database, or other device capable of electronically storing data. The data structure, in some embodiments, is an extensible Markup Language (XML) document. Each element in such an XML document is declared and properties defined. The canvas 300 and the workflow process application of which it is a part include data processing tools, such as menu items, user interfaces, guided “wizard” processes, and the like to assist workflow authors in adding, removing, and modifying elements and the data of the underlying data structure. In some embodiments, the workflow process application includes a palate of elements that may be placed on the canvas 300 in a drag-and-drop fashion. Further, elements within the canvas may also be repositioned in a drag-and-drop fashion.

The data structure that underlies a workflow model presented on the canvas 300 may take different forms depending on the particular embodiment. An example portion of such a data structure according to some embodiments may include:

<element> <elementname:element_1 type:activity ... ></element>
<element> <elementname:element_2 type:activity ... ></element>
<route><route_no:1 routeSource:element_1
routeTarget:element_2></route>

In this example data structure portion, there are two elements declared and a route is provided between the two elements. The ellipsis (i.e., the “ . . . ”) is provided in this example to represent other data defining the elements that may be included, such as data define other properties of the element. These elements maybe grouped. To group the elements, the graphical representations of the elements on the canvas 300 may be selected and a grouping input provided. The elements and the route there between will then be grouped, such as by the element grouping component 106 of FIG. 1 or another grouping process, component, or module depending on the particular embodiment. The grouping includes modification of the underlying data structure and a redrawing of the workflow model presented on the canvas 300, such as by the presentation component 104 of FIG. 1. The resulting changes to the portion of the data structure above may take the form, in some embodiments, of:

```
<group><groupName:group_1 defaultpresentation:collapsed>
    <element> <elementname:element_1 type:activity ... ></element>
    <element> <elementname:element_2 type:activity ... ></element>
    <route><route_no:1 routeSource:element_1
        routeTarget:element_2></route>
</group>
```

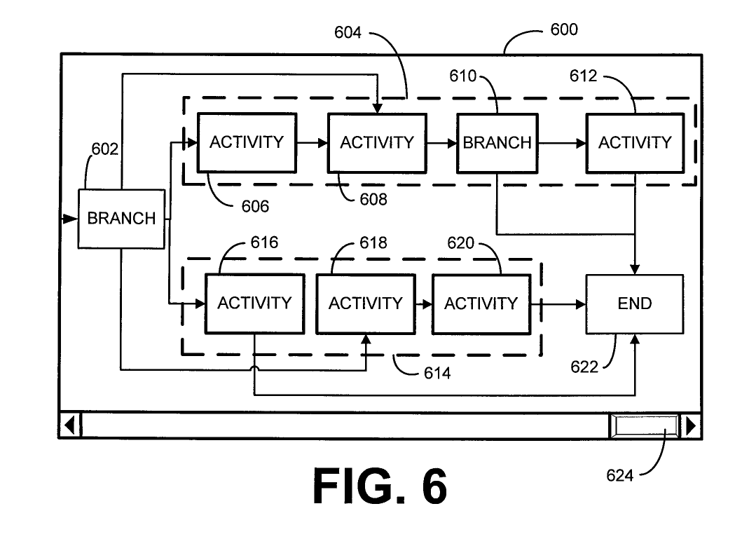

FIG. 6 is a user interface diagram, illustrating a user interface, according to an example embodiment. The user interface of FIG. 6 includes a canvas 600 and several elements 602, 606, 608 610, 612, 616, 618, 620, and 622. The elements 606, 608, 610, and 612 are within a collapsible group 604 and the elements 616, 618, and 620 are within another collapsible group 614. The groups 604 and 614 each include two routes in. Each Group 604 and 614 include two routes in and two routes out. The routes into group 604 are from branch element 602 to activity element 606 and to activity element 608. The routes into group 614 are to activity element 616 and to activity element 618. The routes out of group 604 are from branch element 610 and from activity element 612. The routes out of group 614 are from activity element 616 and from activity element 610. Although the routes into both groups originate from a single branch element 602, the routes may originate from different elements. Further, although as illustrated, all routes from both groups are to a single end element 622, the routes may individually be to different elements. However, there may be one or more routes into a group and one or more routes out of a group. When there is more than one route into a group, the routes may be to a single element within the group, each route may be to a different element in the group, multiple routes to one element and one route to each of one or more other elements, and so on. Similarly, routes out of a group may each be to different elements, all to one element as illustrated in FIG. 6, multiple routes to one element and one or more routes each to one or more other elements and so on.

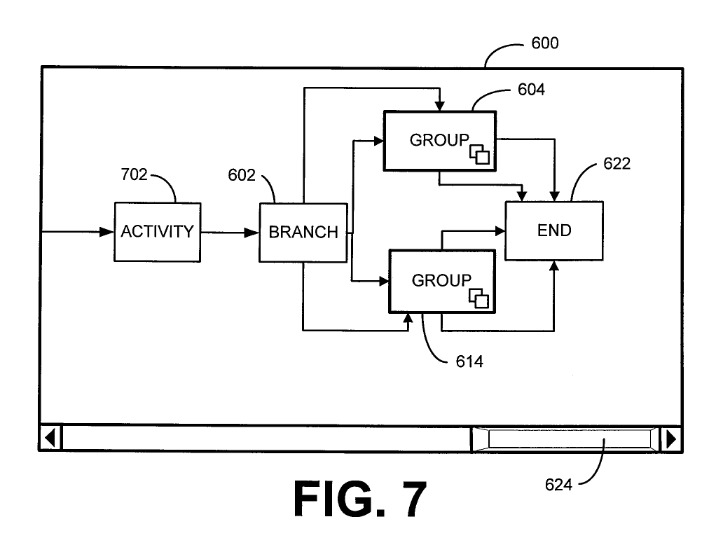

The workflow process modeled on the canvas 600 is larger than is viewable within a viewable area of the canvas 600. Thus, the canvas is scrollable through manipulation of the scroll bar 624. However, the groups 604 and 614 are collapsible, as described above with regard to FIG. 3, FIG. 4, and FIG. 5. A collapsed view of the canvas 600 is illustrated in FIG. 7.

FIG. 7 is a user interface diagram, illustrating a user interface, according to an example embodiment. The user interface of FIG. 7 includes the canvas 600 as described above with regard to FIG. 6. However, the groups 604 and 614 are collapsed into single visible elements, respectively, thereby making more of the modeled workflow visible. For example, element 702 of the modeled workflow is now visible on the canvas 600. Further, the scroll bar 624 is now larger, indicating that the modeled workflow is displayed smaller within the canvas 600. The group elements 604 and 614 are individually selectable for expansion to display all of the elements that they represent.

Although the groups illustrated and described to this point have been groups of elements, a group may include one or more groups. Thus, a group of groups is contemplated as an embodiment. However, when a group is formed to include an existing group, the formed group will include the entirety of the existing group.

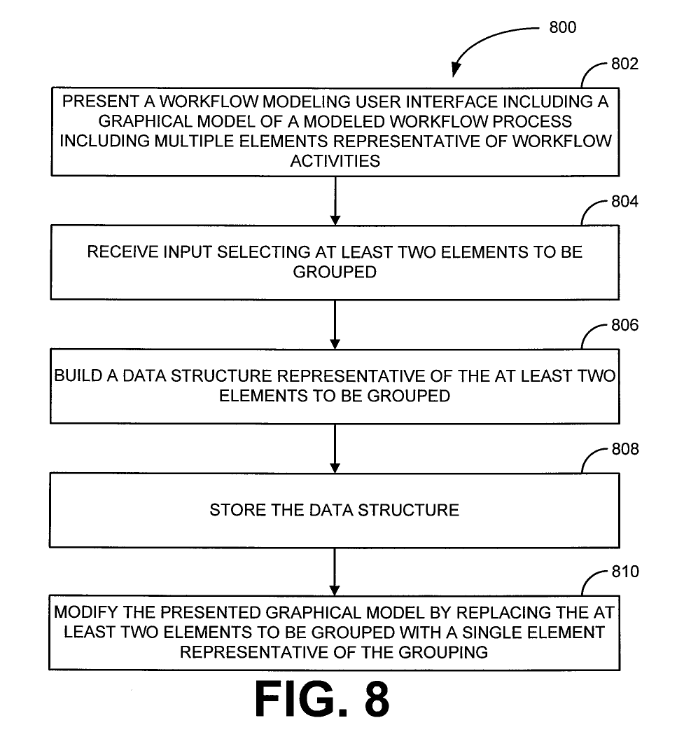

FIG. 8 is a block flow diagram of a method 800 according to an example embodiment. The method 800 is an example of a method performed by a workflow process application. The method 800 includes presenting 802, on a display device connected to a computer performing the method 800, a workflow modeling user interface including a graphical model of a modeled workflow process including multiple elements and receiving 804, via at least one input device of the computer, input selecting at least two elements to be grouped. The method 800 further includes building 806 a data structure representative of the at least two elements to be grouped and storing 808 the data structure in a memory device of the computer. The method 800 also includes modifying 810 the presented graphical model by replacing the at least two elements to be grouped with a single element representative of the grouping. The series of illustrations of FIG. 3, FIG. 4, and FIG. 5 provide examples of such user interfaces.

In some embodiments of the method 800, building 806 the data structure representative of the at least two elements to be grouped includes modifying an existing data structure including data representative of each of the multiple elements to group. In such embodiments, the grouping is performed not only visually through modification 810 of the user interface, but also within the existing data structure.

In some embodiments, workflows authored according to the method 800, at least two of the at least two grouped elements may include a workflow route into the group of elements. Further, at least two of the at least two grouped elements may include a workflow route out of the group of elements.

Modifying 810 the presented graphical model of the workflow process modeled according to the method 800 may include collapsing the at least two grouped elements into a single graphical element in the graphical model. In some such embodiments, the method 800 may further include receiving, via the at least one input device of the computer, an input command to expand the single graphical element within the graphical model to display each of the at least two grouped elements. In response to the received input command, such embodiments include modifying the graphical model by replacing the single graphical element representative of the grouped elements with a group of graphical elements, each graphical element representative one of the at least two grouped elements.

Some embodiments of the method 800 may further include the ability to copy a group within a graphical model and paste the copied group into another portion of the graphical model. For example, the method 800 may include receiving a selection of a single element representative of a group and receiving input to copy the selected single element representative of the group and copying data of the group into a memory device. Such embodiments further include receiving input to paste the copied data of the group into the workflow modeling interface and adding a copy of the copied data of the group into the stored data structure. These embodiments also include adding a graphical element representative of the group to the graphical model, the graphical element including at least one route into and one route out of the graphical element. The routes may then be connected to other elements to complete the workflow model.

An additional embodiment, in the form of a system includes at least one processor, at least one memory device, a video output device such as a graphics card, and at least one input device interconnected via at least one integrated circuit board, such as a motherboard. The system of this embodiment includes a workflow modeling application stored in the at least one memory device and executable by the at least one processor. The workflow modeling application is executable by the at least one processor to present a view of a workflow modeling workspace via signals output by the video output device. The workflow modeling workspace, in some embodiments, is capable of presenting views of modeled workflow processes including interconnected nodes each representing at least one activity, event, or sub-process.

The workflow modeling application is further executable by the at least one processor to receive, via the at least one input device, input selecting at least two nodes of a presented view of a modeled workflow process and a command to group the at least two nodes. Following receipt of the command to group the at least two nodes, the workflow modeling application is executable to modify a data structure from which the presented view of the modeled work flow process was presented to include data designating the selected at least two nodes as members of a group. The data structure is typically stored and modified within the at least one memory device. The workflow modeling application is also executable by the at least one processor to modify the presented view of the modeled workflow process by replacing the at least two nodes to be grouped with a single node representative of the grouping.

The various embodiments target a technical problem of providing a view on a display device as generated by a workflow processing application in a manner that maximizes a users ability to visualize a workflow model in a single view. However, technically solving this problem presented further technical issues, such as how to not only group elements visually, but also in an underlying data structure while maintaining the integrity of the data structure. The various embodiments, as described above, provide a technical solution through programmatic and systematic manipulation of data structures to provide a data structure that may be presented to accomplish a goal of providing better mechanisms for visualization of workflow models.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method comprising:
presenting a workflow modeling user interface including a graphical model of a modeled workflow process including multiple elements;
receiving input selecting at least two graphical workflow elements of the modeled workflow process to be grouped;
building a data structure representative of the at least two graphical workflow elements to be grouped;
storing the data structure in a memory device of the computer;
modifying the presented graphical model by replacing the at least two graphical workflow elements to be grouped with a single graphical workflow element representative of the grouping; and
wherein the building of the data structure and the modifying of the presented graphical model preserves the workflow modeling arrangement and routing to and from and of and between the at least two graphical workflow elements.

2. The method of claim 1, wherein the building of the data structure representative of the at least two elements to be grouped includes:
modifying an existing data structure including data representative of each of the multiple elements to group, the at least two elements to be grouped within the existing data structure.

3. The method of claim 1, wherein at least two of the at least two grouped elements include a workflow route into the group of elements.

4. The method of claim 1, wherein at least two of the at least two grouped elements include a workflow route out of the group of elements.

5. The method of claim 1, wherein the modifying of the presented graphical model of the modeled workflow process includes collapsing the at least two grouped elements into a single graphical element in the graphical model.

6. The method of claim 5, further comprising:
receiving an input command to expand the single graphical element within the graphical model to display each of the at least two grouped elements; and
modifying the graphical model by replacing the single graphical element representative of the grouped elements with a group of graphical elements, each graphical element representative one of the at least two grouped elements.

7. The method of claim 1, wherein the receiving of the input selecting the at least two elements to be grouped includes receiving a selection of at least one element representative of a group of elements, the selected element representative of a group to be grouped with at least one other element.

8. A non-transitory computer-readable storage medium, with instructions stored thereon, which when executed by a processor of a computer, cause the computer to:
present a workflow modeling user interface including a graphical model of a modeled workflow process including multiple elements;
receive data indicative of first input selecting at least two graphical workflow elements to be grouped;
build a data structure representative of the at least two graphical workflow elements to be grouped;
store the data structure;
provide data, in response to the received data indicative of the first input, to modify the graphical model by replacing the at least two graphical workflow elements to be grouped with a single graphical workflow element representative of the grouping; and
wherein the building of the data structure and the modifying of the presented graphical model preserves the workflow modeling arrangement and routing to and from and of and between the at least two graphical workflow elements.

9. The computer-readable storage medium of claim 8, wherein the building of the data structure representative of the at least two elements to be grouped includes:
modifying an existing data structure including data representative of each of the multiple elements to group the at least two elements to be grouped within the existing data structure.

10. The computer-readable storage medium of claim 8, wherein at least two of the at least two grouped elements include a workflow route into the group of elements.

11. The computer-readable storage medium of claim 8, wherein at least two of the at least two grouped elements include a workflow route out of the group of elements.

12. The computer-readable storage medium of claim 8, wherein the providing of the data to modify the graphical model includes data, which when processed, collapses the at least two grouped elements into a single element in the graphical model.

13. The computer-readable storage medium of claim 12, with further instructions stored thereon, which when executed by the processor of the computer, cause the computer to:
receive data indicative of a second input command to expand the single element within the graphical model to display each of the at least two grouped elements; and
provide data, in response to the received data indicative of the second input, to modify the graphical model by replacing the single element representative of the grouped elements with a group of elements, each element representative of an element of the grouped elements.

14. The computer-readable storage medium of claim 8, with further instructions stored thereon, which when executed by the processor of the computer, cause the computer to:
receive a selection of the single element representative of the group;
receive input to copy the selected single element representative of the group and copying data of the group into a memory device;
receive input to paste the copied data of the group into the workflow modeling interface;
add a copy of the copied data of the group into the stored data structure; and
add a graphical element representative of the group to the graphical model, the graphical element including at least one route into and one route out of the graphical element.

15. The computer-readable storage medium of claim 8, wherein the workflow modeling user interface is presented as data over a network to a client computing device capable of presenting a user interface as a function of the provided data.

16. A system comprising:
at least one processor, at least one memory device, a video output device, and at least one input device interconnected via at least one integrated circuit board; and
a workflow modeling application stored in the at least one memory device and executable by the at least one processor to:
present a view of a workflow modeling workspace via signals output by the video output device, the workflow modeling workspace capable of presenting views of modeled workflow processes including interconnected nodes each representing at least one activity, event, or subprocess;
receive, via the at least one input device, input selecting at least two graphical workflow nodes of a presented view of a modeled workflow process within the workflow modeling workspace, the selection of the at least two graphical workflow nodes including a command to group the at least two graphical workflow nodes;
modify a data structure from which the presented view of the modeled work flow process was presented to include data designating the selected at least two graphical workflow nodes as members of a group, the data structure stored and modified within the at least one memory device;
modify the presented view of the modeled workflow process by replacing the at least two graphical workflow nodes to be grouped with a single graphical workflow node representative of the grouping; and
wherein the modifying of the data structure and the modifying of the presented graphical model preserves the workflow modeling arrangement and routing to and from and of and between the at least two graphical workflow nodes.

17. The system of claim 16, wherein at least two of the at least two grouped nodes include a workflow route into the group of nodes.

18. The system of claim 16, wherein at least two of the at least two grouped nodes include a workflow route out of the group of nodes.

19. The system of claim 16, wherein modifying the presented view of the modeled workflow process includes collapsing the at least two grouped nodes into a single graphical node in the graphical model.

20. The system of claim 16, wherein receiving the input selecting the at least two nodes and the input command to group the at least two nodes includes receiving a selection of at least one node representative of a group of nodes, the selected node representative of a group to be grouped with at least one other node.
